(19) United States
(12) Patent Application Publication
(10) Pub. No.: US 2026/0271102 A1
(43) Pub. Date: Sep. 10, 2026

(54) TRANSMISSION METHOD AND APPARATUS, TERMINAL, AND NETWORK SIDE DEVICE

(71) Applicant: VIVO MOBILE COMMUNICATION CO., LTD., Dongguan (CN)

(72) Inventor: Hang YU, Dongguan (CN)

(21) Appl. No.: 19/663,298

(22) Filed: Apr. 30, 2026

Related U.S. Application Data
(63) Continuation of application No. PCT/CN2024/128389, filed on Oct. 30, 2024.

(30) Foreign Application Priority Data
Nov. 3, 2023 (CN) 202311465554.4

(51) Int. Cl. H04W 76/10; H04W 4/12; H04W 76/25

(52) U.S. Cl. CPC H04W 76/10; H04W 4/12; H04W 76/25

(57) ABSTRACT

This application discloses a transmission method and apparatus, a terminal, and a network side device, and belongs to the field of communication technologies. The transmission method in embodiments of this application includes: A terminal receives a first message sent by a first network element. The first message carries first information. The first information indicates at least one of the following: whether a first user plane connection establishment request message sent by the terminal is accepted, a cause for requesting to modify a user plane connection between the terminal and the first network element, or a cause for requesting to release the user plane connection between the terminal and the first network element. The first user plane connection establishment request message is used to request to establish the user plane connection between the terminal and the first network element.

### CROSS-REFERENCE TO RELATED APPLICATIONS

This application is a continuation of International Patent Application No. PCT/CN2024/128389, filed on October 30, 2024, which claims priority to Chinese Patent Application No. 202311465554.4, filed with the China National Intellectual Property Administration on November 3, 2023 and entitled "TRANSMISSION METHOD AND APPARATUS, TERMINAL, AND NETWORK SIDE DEVICE", both of which are incorporated herein by reference in their entireties.

### TECHNICAL FIELD

This application belongs to the field of communication technologies, and in particular, to a transmission method and apparatus, a terminal, and a network side device.

### BACKGROUND

Currently, some mobile communication systems support transfer of a message related to a data service (for example, a positioning service, a perception service, or a computing service) between a terminal and a network side over a user plane. For example, a positioning message may be transferred between the terminal and a location management function (Location Management Function, LMF) over the user plane.

### SUMMARY

Embodiments of this application provide a transmission method and apparatus, a terminal, and a network side device, to provide a manner for managing a user plane operation for a data service between the terminal and a network side.

According to a first aspect, a transmission method is provided. The method includes:

a terminal receives a first message sent by a first network element.

The first message carries first information. The first information indicates at least one of the following: whether a first user plane connection establishment request message sent by the terminal is accepted, a cause for requesting to modify a user plane connection between the terminal and the first network element, or a cause for requesting to release the user plane connection between the terminal and the first network element. The first user plane connection establishment request message is used to request to establish the user plane connection between the terminal and the first network element.

According to a second aspect, a transmission apparatus is provided. The apparatus includes:

a first receiving module, configured to receive a first message sent by a first network element.

The first message carries first information. The first information indicates at least one of the following: whether a first user plane connection establishment request message sent by a terminal is accepted, a cause for requesting to modify a user plane connection between the terminal and the first network element, or a cause for requesting to release the user plane connection between the terminal and the first network element. The first user plane connection establishment request message is used to request to establish the user plane connection between the terminal and the first network element.

According to a third aspect, a transmission method is provided. The method includes:

a first network element sends a first message to a terminal.

The first message carries first information. The first information indicates at least one of the following: whether a first user plane connection establishment request message sent by the terminal is accepted, a cause for requesting to modify a user plane connection between the terminal and the first network element, or a cause for requesting to release the user plane connection between the terminal and the first network element. The first user plane connection establishment request message is used to request to establish the user plane connection between the terminal and the first network element.

According to a fourth aspect, a transmission apparatus is provided. The apparatus includes:

a first sending module, configured to send a first message to a terminal.

The first message carries first information. The first information indicates at least one of the following: whether a first user plane connection establishment request message sent by the terminal is accepted, a cause for requesting to modify a user plane connection between the terminal and a first network element, or a cause for requesting to release the user plane connection between the terminal and the first network element. The first user plane connection establishment request message is used to request to establish the user plane connection between the terminal and the first network element.

According to a fifth aspect, a terminal is provided. The terminal includes a processor and a memory. The memory stores a program or instructions executable on the processor. When the program or the instructions are executed by the processor, the steps of the method according to the first aspect are implemented.

According to a sixth aspect, a terminal is provided, and includes a processor and a communication interface. The communication interface is configured to receive a first message sent by a first network element. The first message carries first information. The first information indicates at least one of the following: whether a first user plane connection establishment request message sent by the terminal is accepted, a cause for requesting to modify a user plane connection between the terminal and the first network element, or a cause for requesting to release the user plane connection between the terminal and the first network element. The first user plane connection establishment request message is used to request to establish the user plane connection between the terminal and the first network element.

According to a seventh aspect, a network side device is provided. The network side device includes a processor and a memory. The memory stores a program or instructions executable on the processor. When the program or the instructions are executed by the processor, the steps of the method according to the third aspect are implemented.

According to an eight aspect, a network side device is provided, and includes a processor and a communication interface. The communication interface is configured to send a first message to a terminal. The first message carries first information. The first information indicates at least one of the following: whether a first user plane connection establishment request message sent by the terminal is accepted, a cause for requesting to modify a user plane connection between the terminal and a first network element, or a cause for requesting to release the user plane connection between the terminal and the first network element. The first user plane connection establishment request message is used to request to establish the user plane connection between the terminal and the first network element.

According to a ninth aspect, a transmission system is provided, and includes a terminal and a network side device. The terminal may be configured to perform the steps of the transmission method according to the first aspect. The network side device may be configured to perform the steps of the transmission method according to the third aspect.

According to a tenth aspect, a readable storage medium is provided. The readable storage medium stores a program or instructions. When the program or the instructions are executed by a processor, the steps of the method according to the first aspect are implemented, or the steps of the method according to the third aspect are implemented.

According to an eleventh aspect, a chip is provided. The chip includes a processor and a communication interface. The communication interface is coupled to the processor. The processor is configured to run a program or instructions, to implement the steps of the method according to the first aspect or the steps of the method according to the third aspect.

According to a twelfth aspect, a computer program/program product is provided. The computer program/program product is stored in a storage medium. The computer program/program product is executed by at least one processor to implement the steps of the method according to the first aspect or the steps of the method according to the third aspect.

In embodiments of this application, the terminal receives the first message sent by the first network element. The first message carries the first information. The first information indicates at least one of the following: whether the first user plane connection establishment request message sent by the terminal is accepted, the cause for requesting to modify the user plane connection between the terminal and the first network element, or the cause for requesting to release the user plane connection between the terminal and the first network element. The first user plane connection establishment request message is used to request to establish the user plane connection between the terminal and the first network element. Therefore, the terminal can perform a corresponding action based on the first information. This helps the terminal and the network device more efficiently use a user plane to transmit a message related to a data service.

### BRIEF DESCRIPTION OF THE DRAWINGS

FIG. 1 is a block diagram of a wireless communication system to which an embodiment of this application may be applied;

FIG. 2a is a flowchart of positioning based on a user plane connection initiated by an LMF between UE and the LMF according to an embodiment of this application;

FIG. 2b is a flowchart of positioning based on a user plane connection initiated by UE between the UE and an LMF according to an embodiment of this application;

FIG. 2c is a flowchart of modifying a user plane connection between UE and an LMF according to an embodiment of this application;

FIG. 3 is a flowchart of a transmission method according to an embodiment of this application;

FIG. 4a is a flowchart of establishing a user plane connection between UE and an LMF according to an embodiment of this application;

FIG. 4b is a flowchart of modifying a user plane connection between UE and an LMF according to an embodiment of this application;

FIG. 4c is a flowchart of releasing a user plane connection between UE and an LMF according to an embodiment of this application;

FIG. 5 is a flowchart of another transmission method according to an embodiment of this application;

FIG. 6 is a diagram of a structure of a transmission apparatus according to an embodiment of this application;

FIG. 7 is a diagram of a structure of another transmission apparatus according to an embodiment of this application;

FIG. 8 is a diagram of a structure of a communication device according to an embodiment of this application;

FIG. 9 is a diagram of a structure of a terminal according to an embodiment of this application; and

FIG. 10 is a diagram of a structure of a network side device according to an embodiment of this application.

### DETAILED DESCRIPTION

The following clearly describes the technical solutions in embodiments of this application with reference to the accompanying drawings in embodiments of this application. Apparently, the described embodiments are a part but not all of embodiments of this application. All other embodiments obtained by a person of ordinary skill in the art based on embodiments of this application fall within the protection scope of this application.

The terms "first", "second", and the like in this application are used to distinguish between similar objects instead of describing a specific order or sequence. It should be understood that the terms used in such a way are interchangeable in appropriate circumstances, so that embodiments of this application can be implemented in other orders than the order illustrated or described herein. Moreover, the objects distinguished by "first" and "second" are usually of one type, and the quantity of objects is not limited. For example, there may be one or more first objects. In addition, "or" in this application indicates at least one of connected objects. For example, "A or B" covers three solutions, that is, a solution 1: including A and excluding B; a solution 2: including B and excluding A; and a solution 3: including both A and B. The character "/" generally indicates an "or" relationship between associated objects.

The term "indication" in this application may be a direct indication (or an explicit indication), or may be an indirect indication (or an implicit indication). The direct indication may be understood as that a sending party explicitly notifies a receiving party of content such as specific information, an operation that needs to be performed, or a request result in a sent indication. The indirect indication may be understood as that a receiving party determines corresponding information based on an indication sent by a sending party, or performs determining and determines, based on a determining result, an operation that needs to be performed, a request result, or the like.

It should be noted that a technology described in embodiments of this application is not limited to a long term evolution (Long Term Evolution, LTE)/LTE-advanced (LTE-Advanced, LTE-A) system, and may also be applied to another wireless communication system, for example, code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-carrier Frequency Division Multiple Access, SC-FDMA), or another system. The terms "system" and "network" in embodiments of this application are often used interchangeably, and the described technology may be applied to the above-mentioned systems and radio technologies as well as other systems and radio technologies. A new radio (New Radio, NR) system is described below as an example, and the term NR is used in most of the following descriptions. Nevertheless, the technologies may also be applied to a system other than the NR system, for example, a 6^{th} generation (6^{th} Generation, 6G) communication system.

However, in a related technology, there is no corresponding solution for managing a user plane operation (for example, establishment, modification, or release of a user plane connection) for the data service between the terminal and the network side. This may easily affect an effect of transmitting the message related to the data service between the terminal and the network side over the user plane. Embodiments of this application provide a transmission method and apparatus, a terminal, and a network side device, to provide a manner for managing a user plane operation for a data service between the terminal and a network side, helping the terminal and the network side more efficiently use a user plane to transmit a message related to the data service.

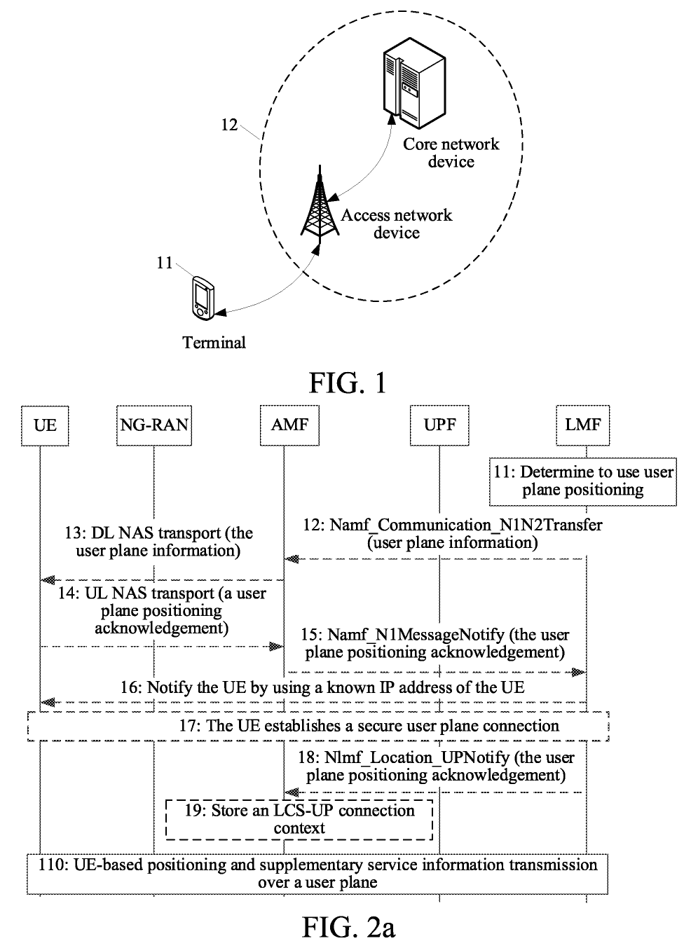

FIG. 1 is a block diagram of a wireless communication system to which an embodiment of this application may be applied. The wireless communication system includes a terminal 11 and a network side device 12. The terminal 11 may be a terminal side device such as a mobile phone, a tablet computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), augmented reality (Augmented Reality, AR), a virtual reality (Virtual Reality, VR) device, a robot, a wearable device (Wearable Device), a flight vehicle (flight vehicle), an in-vehicle device (Vehicle User Equipment, VUE), a shipborne device, a pedestrian terminal (Pedestrian User Equipment, PUE), a smart home (a home device with a wireless communication function, for example, a refrigerator, a television, a washing machine, or furniture), a game console, a personal computer (Personal Computer, PC), a teller machine, or a self-service machine. The wearable device includes a smartwatch, a smart band, a smart headset, smart glasses, a smart jewelry (a smart bracelet, a smart chain bracelet, a smart ring, a smart necklace, a smart ankle bangle, a smart ankle chain, and the like), a smart wristband, smart clothing, and the like. The in-vehicle device may also be referred to as an in-vehicle terminal, an in-vehicle controller, an in-vehicle module, an in-vehicle component, an in-vehicle chip, an in-vehicle unit, or the like. It should be noted that a specific type of the terminal 11 is not limited in embodiments of this application. The network side device 12 may include an access network device or a core network device. The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AP), a wireless fidelity (Wireless Fidelity, Wi-Fi) node, or the like. The base station may be referred to as a NodeB (NodeB, NB), an evolved NodeB (Evolved NodeB, eNB), a next generation NodeB (next generation NodeB, gNB), a new radio NodeB (New Radio NodeB, NR NodeB), an access point, a relay station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home NodeB, HNB), a home evolved NodeB (home evolved NodeB), a transmission reception point (Transmission Reception Point, TRP), or another suitable term in the field. As long as the same technical effects are achieved, the base station is not limited to a specific technical word. It should be noted that in embodiments of this application, a base station in an NR system is used merely as an example for description, and a specific type of the base station is not limited.

The core network device may include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF) unit, an edge application server discovery function (Edge Application Server Discovery Function, EASDF), unified data management (Unified Data Management, UDM), a unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF or L-NEF), a binding support function (Binding Support Function, BSF), an application function (Application Function, AF), and the like. It should be noted that in embodiments of this application, the core network device in the NR system is used merely as an example for description, and a specific type of the core network device is not limited.

For ease of understanding, the following describes some content in embodiments of this application.

Release 18 (Release 18, R18) supports transfer of a positioning message (including an LTE positioning protocol (LTE Positioning Protocol, LPP) message and a location service supplementary service (Location Service Supplementary Service, LCS-SS) message) between UE and a network side (including an LMF and a location services (Location Services, LCS) client (client)/AF) over a user plane. The following provides a location service related procedure, including UE triggered user plane establishment, network triggered user plane establishment, network triggered user plane modification, and network triggered user plane release.

1. LMF initiated/triggered user plane connection

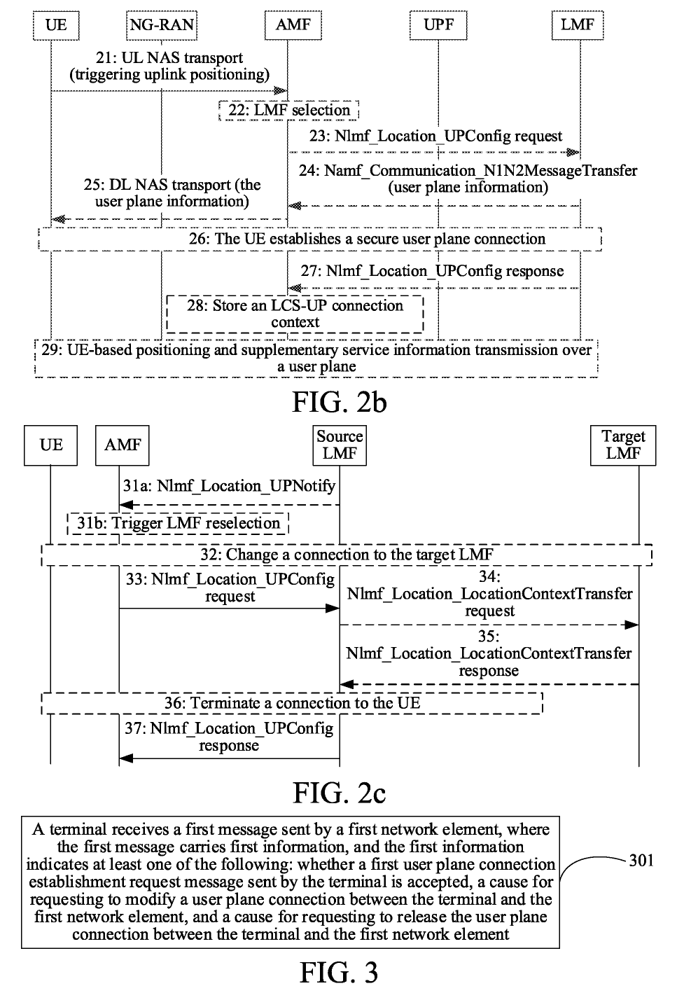

For example, refer to FIG. 2a. An LMF initiated/triggered user plane connection procedure may include the following steps.

Step 11: The LMF determines, based on a user plane positioning capability of UE, a control plane congestion status (for example, a load status of an AMF), and another execution factor, whether to use a positioning procedure over a user plane connection between the UE and the LMF.

The LMF may invoke an Nnrf_NFCDiscovery service operation to obtain the control plane congestion status (for example, load information of the AMF). If there is an available user plane connection between the UE and the LMF, the LMF may determine, based on the load information of the AMF, to use user plane positioning.

If a user plane connection context between the UE and the LMF already exists in the LMF, and the LMF determines to use the user plane connection to perform positioning, step 12 to step 17 are skipped.

It should be noted that the LMF may select user plane positioning for a specific positioning method (for example, a method based on a motion sensor). The specific positioning method that needs user plane transmission depends on an implementation and a local configuration.

Step 12: [Conditionally] If the LMF determines to use the user plane to perform positioning, and no secure user plane connection is established between the terminal and the LMF, the LMF invokes an Namf_communication_N1N2Transfer service operation, puts user plane information in a non-access layer (Non-access Stratum, NAS) container, and sends the user plane information to the AMF, to indicate the terminal to perform user plane positioning by using TLS. The user plane information includes a user plane positioning address and security-related information of the LMF.

Step 13: [Conditionally] When the AMF receives the user plane information from the LMF in step 12, the AMF sends the user plane information to the UE by using a DL NAS transport (DL NAS TRANSPORT) message.

Step 14: [Conditionally] If no applicable protocol data unit (Protocol Data Unit, PDU) session is established for user plane positioning, the terminal establishes a PDU session for user plane positioning by using a user equipment route selection policy (UE Route Selection Policy, URSP) (including a PDU session parameter related to user plane positioning, for example, a dedicated data network name (Data Network Name, DNN) and single network slice selection assistance information (Single Network Slice Selection Assistance Information, S-NSSAI)) defined in a related protocol. The UE may send an acknowledgement to the LMF via the AMF, to indicate that the user plane connection is successfully used for a positioning service, or the user plane connection fails to be used, for example, no appropriate PDU session is established.

Step 15: [Conditionally] The AMF sends an acknowledgement message received in step 14 to the LMF by using an Namf_N1messageNotify service.

Step 16: [Conditionally] If the LMF knows IP address information of the UE, the LMF may indicate the UE to establish a secure user plane connection by using a known IP address.

Step 17: [Conditionally] The UE establishes the secure user plane connection to the LMF. If the LMF sends a fully qualified domain name (Fully Qualified Domain Name, FQDN) to the UE, an IP address of the LMF is parsed via a domain name system (Domain Name System, DNS) server/parser (for example, an edge application server discovery function (Edge Application Server Discovery Function, EASDF) or a local DNS performs local LMF address parsing).

Step 18: [Conditionally] The LMF indicates, in an Nlmf_Location_UPNotify message, the AMF that the user plane connection between the UE and the LMF has been established.

Step 19: [Conditionally] The AMF stores an LCS user plane (LCS User Plane, LCS-UP) connection context as a part of a UE context.

Step 110: If the LMF or the UE determines to use the user plane connection to perform positioning, and the secure user plane connection is established, an LPP message is transferred between the UE and the LMF, to perform UE-based positioning, UE-assisted positioning, and auxiliary data transmission. A supplementary service event report message from the UE may also be transmitted to the LMF by using the established user plane connection.

2. UE initiated user plane connection (UE initiated User Plane Connection)

If there is no user plane connection between UE and an LMF, the UE may trigger establishment of a user plane connection. For example, FIG. 2b shows a UE initiated/triggered user plane connection procedure between a UE and an LMF, which specifically includes the following steps.

Step 21: If determining to request a user plane connection for an upcoming positioning request, the UE sends a user plane establishment request to an AMF by using a NAS message (Message).

Step 22: [Conditionally] If the UE is authorized, in a UE subscription manner, to use user plane positioning, the AMF selects an LMF that can establish a user plane positioning session with the UE. The AMF may query an NRF, or may find and select an appropriate LMF based on a local configuration.

Step 23: [Conditionally] The AMF sends an Nlmf_Location_UPConfig request (Request) to the LMF, to request to establish an LCS-UP connection.

Step 24: [Conditionally] If the LMF accepts user plane positioning, and no secure user plane connection is established between the UE and the LMF, the LMF sends user plane information to the AMF, to indicate the UE to accept and perform user plane positioning. The user plane information includes a user plane positioning address and security-related information of the LMF.

Step 25: [Conditionally] When the AMF receives the user plane information from the LMF in step 24, the AMF forwards the user plane information to the UE by using a DL NAS transport (TRANSPORT) message.

Step 26: [Conditionally] If no secure user plane connection is established, the UE establishes a secure user plane connection to the LMF. The UE determines a PDU session parameter, including a DNN and S-NSSAI, based on the user plane positioning address of the LMF and with reference to information in a URSP. The UE establishes a PDU session by using the PDU session parameter. After receiving a request, an SMF selects an appropriate UPF based on the DNN and the S-NSSAI, and establishes a connection between the UPF and the LMF.

Step 27: [Conditionally] The LMF responds to the AMF that the user plane connection between the UE and the LMF is already established.

Step 28: [Conditionally] The AMF stores an LCS-UP connection context as a part of a UE context.

Step 29: [Conditionally] After the secure user plane connection is established, if the LMF determines to use the user plane connection to perform positioning after receiving the positioning request from the AMF, or the UE determines to use the user plane connection to perform positioning, an LPP message is transferred between the UE and the LMF, to perform UE-based positioning, UE-assisted positioning, and auxiliary data transmission. A supplementary service event report message from the UE may also be transmitted to the LMF by using the established user plane connection.

3. Modification of a user plane connection between UE and an LMF (Modification of User Plane Connection between UE and LMF)

For example, FIG. 2c shows a procedure of modifying a secure user plane connection between UE and an LMF. The procedure describes a change of the LMF, but is also applicable to a case in which a source LMF and a target LMF are the same. The procedure may also be applied to termination of a user plane connection to the source LMF without selecting any target LMF.

Step 31a: [Conditionally] The LMF finds that the LMF needs to be changed, the user plane connection between the UE and the LMF needs to be re-established, or the user plane connection needs to be terminated. The LMF sends an Nlmf_Location_UPNotify message, where the message includes a connection change (termination and establishment) or a termination requirement. If the connection change is requested, the message may include a target LMF identifier. An address of an AMF is provided to the LMF as a "notification target address" in a latest Nlmf_Location_UPConfig message or Nlmf_Location_UP subscription message.

It should be noted that an LMF change process is independent of a session and service continuity mode (Session and Service Continuity Mode, SSC) of a PDU session, and there is a dedicated DNN for positioning. For an SSC mode 2/3, a connection between a PDU session anchor (PDU Session Anchor, PSA) UPF and the LMF may be relocated as the UE moves, and the LMF may find that the LMF needs to be changed to reduce a user plane path delay.

Step 31b: [Conditionally] When the AMF performs user plane positioning based on the target LMF identifier received from the source LMF, or when the UE moves to a new location (which may be outside a service area of the source LMF but in a service area of the target LMF), the AMF may perform LMF reselection, to select the target LMF for the current location of the UE based on a service area of the LMF, user plane positioning capability information of the LMF, and other information listed in Clause 5.1. The LMF needs to be capable of establishing a user plane session, to perform positioning with the UE. In addition, when the AMF is repositioned, a target AMF needs to notify the LMF of the change of the AMF.

Step 32: [Conditionally] If the AMF has been re-allocated, skip step 33. If the AMF has not been re-allocated, step 21 to step 29 in FIG. 2b are performed between the AMF, the UE, and the target LMF, and the UE also terminates the connection to the source LMF.

Step 33: The AMF sends an Nlmf_Location_UPConfig request (Request) to the source LMF. The message may include a request of the source LMF for terminating a specific user plane connection to the UE and the target LMF identifier. Alternatively, the message may include information about AMF reallocation.

Step 34 and step 35: [Conditionally] The source LMF may invoke an Nlmf_Location_LocationContextTransfer request service operation to the target LMF, to provide a current location context of the UE. If there is a context for periodic and triggered UE location event reporting, the target LMF notifies the source LMF of a result of a location context transfer operation.

Step 36: [Conditionally] If the connection between the user plane and the source LMF is still in an active state, the source LMF terminates the connection to the UE.

Step 37: The LMF sends an Nlmf_Location_UPConfig response message to the AMF, to confirm connection termination or confirm the change of the AMF. If the process is for termination, the AMF releases an LCS-UP context after receiving the response message.

The following describes in detail a transmission method provided in embodiments of this application by using some embodiments and application scenarios thereof with reference to the accompanying drawings. In addition, for ease of understanding, embodiments of this application are described by using an example in which a data service is a positioning service.

FIG. 3 is a flowchart of a transmission method according to an embodiment of this application. The method may be performed by a terminal. As shown in FIG. 3, the method includes the following step.

Step 301: The terminal receives a first message sent by a first network element.

The first message carries first information. The first information indicates at least one of the following: whether a first user plane connection establishment request message sent by the terminal is accepted, a cause for requesting to modify a user plane connection between the terminal and the first network element, or a cause for requesting to release the user plane connection between the terminal and the first network element. The first user plane connection establishment request message is used to request to establish the user plane connection between the terminal and the first network element.

In this embodiment, the first network element may include but is not limited to an LMF, an AF, a network data analytics function (Network Data Analytics Function, NWDAF), or the like.

That the first information indicates whether the first user plane connection establishment request message sent by the terminal is accepted may be understood as that the first information indicates whether the first network element accepts the first user plane connection establishment request message sent by the terminal. For example, the first information indicates that the first network element accepts the first user plane connection establishment request message sent by the terminal, that is, agrees to establish the user plane connection. Alternatively, the first information indicates that the first network element rejects the first user plane connection establishment request message sent by the terminal, that is, does not agree to establish the user plane connection. It should be noted that the first information may explicitly indicate whether the first user plane connection establishment request message sent by the terminal is accepted. For example, the first information includes a first message type, and the first message type indicates that a user plane connection establishment request is rejected or accepted. Alternatively, the first information may implicitly indicate whether the first user plane connection establishment request message sent by the terminal is accepted. For example, if the first information includes a cause value or back-off time, it indicates that a user plane connection establishment request is rejected; or if the first information does not include a cause value or back-off time, it indicates that a user plane connection establishment request is accepted.

The cause for requesting to modify the user plane connection between the terminal and the first network element may include but is not limited to causes such as congestion of the network element, exceeding a service area of the network element, resource inadequacy, or protocol switching.

The cause for requesting to release the user plane connection between the terminal and the first network element may include but is not limited to causes such as normal release, protocol switching, resource inadequacy, or restart of the network element.

The following describes this embodiment of this application by using an example in the following cases.

Case 1: The first information indicates whether the first user plane connection establishment request message sent by the terminal is accepted.

The UE triggers or a network triggers establishment of the user plane connection, and the UE sends the first user plane connection establishment request message to the first network element. The first user plane connection establishment request message is used to request to establish the user plane connection between the UE and the first network element to transfer data. For example, the first user plane connection establishment request message may carry a message type, and the message type indicates that the message is a user plane connection establishment request message.

When receiving the first user plane connection establishment request message, the first network element may send a user plane connection establishment response message to the terminal. The message carries the first information indicating whether the first user plane connection establishment request message sent by the terminal is accepted. When receiving the user plane connection establishment response message, the terminal may perform a corresponding operation based on the first information. For example, if the first information indicates that the user plane connection establishment request is rejected, the terminal may send a user plane connection establishment request message again to the first network element again after waiting for preset time, or may perform a corresponding operation based on a cause why the first network element rejects the user plane connection establishment request. For example, if the cause for rejection is protocol mismatch, the UE may re-initiate a terminal initiated user plane connection procedure (refer to the foregoing UE triggered user plane connection procedure) after waiting for preset time, and requests a network side to select a network element supporting a protocol used by the terminal to establish the user plane connection, where the preset time may be locally implemented by the UE, or may be indicated by the network side to the UE by using the first message. If the first information indicates that the user plane connection establishment request is accepted, the terminal may establish the user plane connection to the first network element.

Case 2: The first information indicates the cause for requesting to modify the user plane connection between the terminal and the first network element.

In a case in which a network side (for example, the first network element or a second network element) determines that the first network element needs to be switched, the first network element sends, to the terminal, a user plane connection modification request message used to request the terminal to switch the user plane connection to a target network element, where the message carries the first information indicating the cause for requesting to modify the user plane connection between the terminal and the first network element. When receiving the first message, the terminal may perform a corresponding operation based on the first information. For example, if the first information indicates that the cause for requesting to modify the user plane connection is congestion of the first network element, the terminal may maintain the user plane connection to the first network element, and send a user plane positioning message after waiting for preset time, where the preset time may be locally implemented by the UE, or may be indicated by the network side to the UE by using the first message. If the first information indicates that the cause for requesting to modify the user plane connection is resource inadequacy, the terminal may maintain the user plane connection to the first network element, and send a user plane positioning message after waiting for preset time, where the preset time may be locally implemented by the UE, or may be indicated by the network side to the UE by using the first message. If the first information indicates that the cause for requesting to modify the user plane connection is exceeding the service area of the first network element or protocol switching, the terminal may initiate a new user plane connection establishment request message to the target network element. For example, the second network element may be an AMF.

Case 3: The first information indicates the cause for requesting to release the user plane connection between the terminal and the first network element.

In a case in which a network side (for example, the first network element or a second network element) determines that the user plane connection between the first network element and the terminal needs to be released, the first network element sends, to the terminal, a user plane connection release request message used to request to release the user plane connection between the current terminal and the first network element, where the message carries the first information indicating the cause for requesting to release the user plane connection between the terminal and the first network element. When receiving the first message, the terminal may perform a corresponding operation based on the first information. For example, if the first information indicates that the cause for requesting to release the user plane connection is normal release, the terminal may reject to release the user plane connection to the first network element. If the first information indicates that the cause for requesting to release the user plane connection is protocol switching, restart of the first network element, or the like, the terminal may release the user plane connection to the first network element, and after releasing the user plane connection, use a target protocol to establish a user plane connection to the first network and communicate with the first network element, where the target protocol may be locally selected by the UE, or may be indicated by the first network element to the UE by using the first message. If the first information indicates that the cause for requesting to release the user plane connection is resource inadequacy, the terminal may release the user plane connection to the first network element, and send a user plane positioning connection request procedure after waiting for preset time, where the preset time may be locally implemented by the UE, or may be indicated by the network side to the UE by using the first message. For example, the second network element may be an AMF.

According to the method provided in this embodiment of this application, the terminal receives the first message sent by the first network element. The first message carries the first information. The first information indicates at least one of the following: whether the first user plane connection establishment request message sent by the terminal is accepted, the cause for requesting to modify the user plane connection between the terminal and the first network element, or the cause for requesting to release the user plane connection between the terminal and the first network element. The first user plane connection establishment request message is used to request to establish the user plane connection between the terminal and the first network element. Therefore, the terminal can perform a corresponding action based on the first information. This helps the terminal and the network device more efficiently use a user plane to transmit a message related to a data service.

Optionally, in a case in which the first information indicates whether the first user plane connection establishment request message sent by the terminal is accepted, the first information includes at least one of the following: a first message type, a first cause value, or the back-off time. The first message type indicates that the user plane connection establishment request is rejected or accepted. The first cause value indicates congestion of the first network element or protocol mismatch.

In this embodiment, the first cause value represents the cause for rejecting or not accepting the first user plane connection establishment request message sent by the terminal. The cause for rejecting or not accepting the first user plane connection establishment request message sent by the terminal may include congestion of the first network element or protocol mismatch. For protocol mismatch, for example, the terminal uses an LCS user plane positioning (LCS User Plane Positioning, LCS-UPP) protocol, and the first network element supports only a secure user plane location (Secure User Plane Location, SUPL) protocol. The back-off time (Back-off Time) represents time required by the terminal to wait for, for sending a user plane connection establishment request again.

In this embodiment, the first information includes at least one of the first message type, the first cause value, or the back-off time. This helps the terminal more accurately perform a corresponding user plane operation.

Optionally, the method further includes:

the terminal starts a timer in a case in which the first information includes the back-off time, and sends a second user plane connection establishment request message to the first network element after the timer expires, where an initial value of the timer is the back-off time; or

the terminal sends a third user plane connection establishment request message to the second network element in a case in which the first cause value indicates protocol mismatch, where the third user plane connection establishment request message includes at least one of the following: first indication information or the protocol used by the terminal, where the first indication information indicates the second network element to select a third network element supporting the protocol used by the terminal.

In an implementation, in the case in which the first information includes the back-off time, the terminal may send a user plane connection establishment request message (that is, the second user plane connection establishment request message) to the first network element again after waiting for the back-off time. For example, the terminal may start the timer at a first moment or after a first moment, and send the second user plane connection establishment request message to the first network element after the timer expires. The first moment is a moment at which the terminal obtains the back-off time. This helps quickly establish the user plane connection between the terminal and the first network element.

In some optional embodiments, the terminal may send the second user plane connection establishment request message to the first network element over a user plane. An example in which the first network element is an LMF is used, and the terminal may send the second user plane connection establishment request message to the LMF sequentially via a RAN and a UPF.

In some optional embodiments, in a case in which the first information includes the first cause value and the back-off time, and the first cause value indicates congestion of the first network element, the terminal starts the timer, and sends the second user plane connection establishment request message to the first network element after the timer expires.

In another implementation, in a case in which the first cause value indicates protocol mismatch, the terminal sends the third user plane connection establishment request message to the second network element. A type of the second network element is different from a type of the first network element. For example, the first network element is an LMF, and the second network element is the AMF. The first indication information indicates the second network element to select the third network element supporting the protocol used by the terminal. A type of the third network element is the same as the type of the first network element. For example, the first network element and the third network element are different LMFs. For example, if the protocol used by the terminal is the LCS-UPP protocol, the third user plane connection establishment request message carries the LCS-UPP protocol.

It may be understood that when receiving the third user plane connection establishment request message, the second network element may select, for the terminal, the third network element supporting the protocol used by the terminal. For example, if the protocol used by the terminal is the LCS-UPP protocol, the AMF may select, for the terminal, an LMF supporting the LCS-UPP protocol.

In this implementation, in a case in which the first network element does not support the protocol used by the terminal, the terminal may quickly request the second network element to select, for the terminal, a network element supporting the protocol used by the terminal. This helps the terminal quickly establish a user plane connection to the network element supporting the protocol used by the terminal.

In still another implementation, in a case in which the first information includes the back-off time and the first cause value, and the first cause value is protocol mismatch, the terminal starts the timer, and sends the second user plane connection establishment request message to the first network element after the timer expires, or the terminal starts the timer, and sends the third user plane connection establishment request message to the second network element after the timer expires. The third user plane connection establishment request message includes at least one of the following: the first indication information or the protocol used by the terminal. The first indication information indicates the second network element to select the third network element supporting the protocol used by the terminal.

Optionally, the first user plane connection establishment request message is a user plane connection establishment request message sent by the terminal to the first network element over the user plane.

In this embodiment, the terminal sends the user plane connection establishment request message to the first network element over the user plane, to request to establish the user plane connection between the terminal and the first network element.

The following describes a user plane connection establishment procedure by using an example in which a data service is a positioning service and the first network element is an LMF.

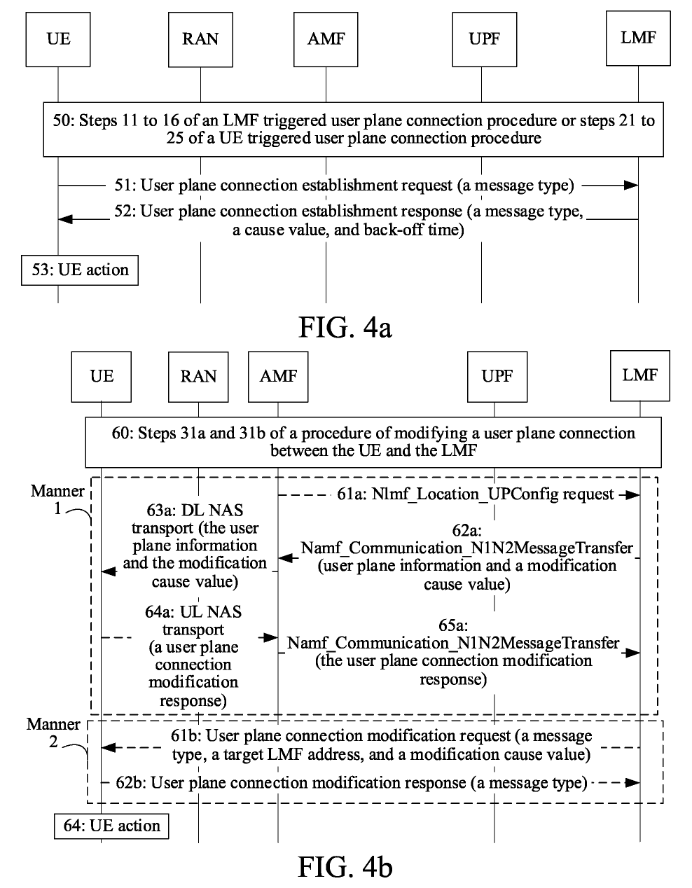

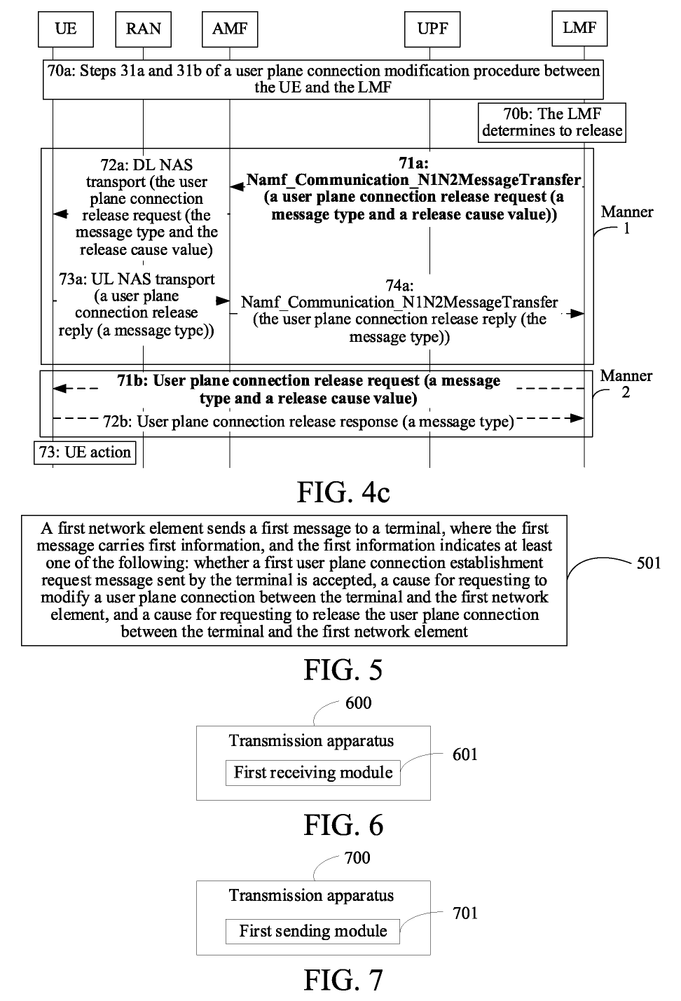

As shown in FIG. 4a, a user plane connection establishment procedure between UE and an LMF may include the following steps.

Step 50: The UE triggers or a network triggers the user plane connection establishment procedure. For details, refer to step 11 to step 16 of the foregoing LMF triggered user plane connection procedure or step 21 to step 25 of the foregoing UE triggered user plane connection procedure.

It should be noted that in step 50, control plane signaling is used, all messages are transferred over a control plane, and no UPF is involved.

Step 51: The UE sends a user plane connection establishment request message to the LMF, where the message is used to request to establish a user plane connection between the UE and the LMF, to transfer a user plane positioning message, and the message may carry a message type (Message type) indicating that the message is a user plane connection establishment request message, and expected connection duration indicating duration for which the UE expects to use the user plane connection. The expected connection duration may be represented as a time period, for example, from 0:00 on October 1 to 20:00 on the same day, or may be represented as time duration, for example, five hours.

It should be noted that the user plane connection establishment request message is sent over a user plane, that is, a user plane channel UE->RAN->UPF->LMF.

Step 52: The LMF sends, to the UE, a user plane connection establishment response message indicating a result of the request of the UE for establishment of the user plane connection, where the message carries at least one of the following: a message type, a cause value, or back-off time, where the message type includes one of request acceptance or request rejection, and the cause value includes one of congestion of the LMF and protocol mismatch.

Step 53: The UE performs a corresponding action after receiving the user plane connection establishment response message.

In an implementation, when the message type indicates request rejection, the cause value indicates congestion of the LMF, and the back-off time is carried, the UE starts a timer after receiving the cause value and the back-off time, where an initial value of the timer is the back-off time; and sends the user plane connection establishment request message to the LMF again after the timer expires.

In another implementation, when the message type indicates request rejection, and the cause value indicates protocol mismatch, the UE performs step 21 of the UE triggered user plane connection procedure after receiving the cause value. The sent message carries indication information, where the indication information is used to request an AMF to perform LMF selection, to select an LMF that supports a protocol stack used by the UE.

Optionally, in a case in which the first information indicates the cause for requesting to modify the user plane connection between the terminal and the first network element, the first information includes a second cause value. The second cause value indicates at least one of the following: congestion of the first network element, movement of the terminal out of a service area of the first network element, resource inadequacy, or protocol switching.

In this embodiment, the second cause value indicates the cause for requesting to modify the user plane connection between the terminal and the first network element. The cause for requesting to modify the user plane connection between the terminal and the first network element may include at least one of the following: congestion of the first network element, movement of the terminal out of the service area of the first network element, resource inadequacy, or protocol switching.

For example, protocol switching may be that the first network element determines that a currently used protocol stack needs to be switched to transmit a message related to a data service. For example, the LMF determines that a currently used protocol stack needs to be switched to transmit the positioning message.

It may be understood that when obtaining the second cause value, the terminal may perform a corresponding action based on the second cause value. For example, in a case in which the second cause value indicates protocol switching or movement of the terminal out of the service area of the first network element, the terminal may initiate a terminal triggered user plane connection procedure to the network side, to request a new network element address (for example, an LMF address) to establish a new user plane connection. In a case in which the second cause value indicates congestion of the first network element, the terminal may send the user plane connection establishment request to the target network element, or may reject the request of the first network element for modifying the user plane connection between the terminal and the first network element. In a case in which the second cause value indicates resource inadequacy, the terminal may suspend sending a user plane message (for example, a positioning message), and send the user plane message (for example, the positioning message) after waiting for preset time, or the terminal may release a current user plane connection, and initiate a terminal triggered user plane connection procedure to the network side, to request a new network element address (for example, an LMF address) to establish a new user plane connection.

Optionally, the first information further includes at least one of the following: a second message type or a target network element address, where the second message type indicates that the first message is used to request to modify the user plane connection.

In this embodiment, a type of the target network element is the same as the type of the first network element. For example, the target network element and the first network element are different LMFs. It may be understood that in a case in which the first information includes the target network element address, the terminal may initiate a user plane connection establishment request message to the target network element based on the target network element address.

In some optional embodiments, in a case in which the second cause value indicates protocol switching, the first information further includes a target protocol.

In an optional implementation, the first information carries a target protocol information element (Target Protocol Information Element). The target protocol information element includes a first bit. The first bit represents whether the terminal is required to be switched to a protocol A (for example, the SUPL protocol). When a value of the first bit is 0, the terminal is not required to use the protocol A to transmit a user plane message, for example, a positioning message; or when a value of the first bit is 1, the terminal is required to use the protocol A to transmit a user plane message, for example, a positioning message.

Optionally, the first message is a message sent by the first network element to the terminal over the user plane, or the first message is a message sent by the first network element to the terminal over the control plane.

In an implementation, the first network element may send the first message to the terminal over the user plane. For example, the first network element sends a user plane connection modification request (User plane connection modification request) message (that is, the first message) to the terminal over the user plane, where the message carries at least one of a message type (that is, the second message type), the target network element address, or a modification cause value (that is, the second cause value).

In another implementation, the first network element may send the first message to the terminal over the control plane. For example, an example in which the first network element is an LMF is used. The AMF sends an Nlmf_Location_UPConfig request message to the LMF, to request to establish an LCS-UP connection. If the LMF accepts user plane positioning, and no secure user plane connection is established between the UE and the LMF, the LMF sends an Namf_Communication_N1N2MessageTransfer message to the AMF, where the message carries user plane information and a modification cause value (that is, the second cause value). When the AMF receives the user plane information and the modification cause value from the LMF, the AMF forwards the user plane information and the modification cause value to the UE by using a DL NAS transport message.

Optionally, the method further includes:

the terminal sends a second message to the first network element, where the second message indicates that a user plane connection modification request is accepted or rejected.

For example, that the second message indicates that the user plane connection modification request is accepted or rejected may be understood as that the second message indicates that the user plane connection modification request message sent by the first network element is accepted or rejected.

In some examples, the second message may carry a third message type, and the third message type indicates that the user plane connection modification request is accepted or rejected.

Specifically, the terminal may determine, based on the first information, whether to accept the user plane connection modification request; and when determining to accept the user plane connection modification request, send, to the first network element, a message indicating that the user plane connection modification request is accepted; or when determining to reject the user plane connection modification request, send, to the first network element, a message indicating that the user plane connection modification request is rejected.

The following describes a user plane connection modification procedure by using an example in which a data service is a positioning service and the first network element is an LMF.

As shown in FIG. 4b, a user plane connection modification procedure between UE and an LMF may include the following steps.

Step 60: The LMF or an AMF triggers LMF switching to be performed. For example, because the UE moves out of a service area of the LMF, or a load of the LMF is excessively large, the LMF needs to be switched. For details, refer to step 31aand step 31bof the foregoing user plane connection modification procedure between the UE and the LMF.

The LMF sends a modification cause value (modification cause or mod cause) to the UE in the following two manners: Manner 1: sending to the UE by using a control plane message (that is, LMF->AMF->UE); and Manner 2: sending to the UE by using a user plane message (that is, LMF->UPF->RAN->UE).

For Manner 1, refer to step 23 to step 25 of the foregoing UE initiated user plane connection procedure. An enhanced part is that in addition to user plane information (user plane information), the modification cause value is further carried in step 22. The modification cause value includes congestion of the LMF, movement of the UE out of the service area of the LMF, resource inadequacy, or protocol switching. The user plane information is used to provide user plane connection related information, including an LMF address. Specifically, Manner 2 may include the following steps.

Step 61a: The AMF sends an Nlmf_Location_UPConfig request to the LMF, to request to establish an LCS-UP connection. When the AMF receives the user plane information and the modification cause value from the LMF, the AMF forwards the user plane information and the modification cause value to the UE by using a DL NAS transport message.

Step 62a: If the LMF accepts user plane positioning, and no secure user plane connection is established between the UE and the LMF, the LMF sends an Namf_Communication_N1N2MessageTransfer message to the AMF, where the message carries the user plane information and the modification cause value (that is, the second cause value).

Step 63a: When the AMF receives the user plane information and the modification cause value from the LMF, the AMF forwards the user plane information and the modification cause value to the UE by using the DL NAS transport message.

Step 64a: The UE sends a user plane connection modification response message, where the message may carry a message type indicating that the foregoing user plane connection modification request is rejected or accepted, and the message is encapsulated in a UL NAS transport message and sent to the AMF.

Step 65a: When the AMF receives the UL NAS transport message from the UE, the AMF finds an LMF based on an LCS-UP context of the UE, and forwards the user plane connection modification response message carried in the UL NAS transport message to the UE.

Manner 2 may include the following steps.

Step 61b: The LMF sends a user plane connection modification request message to the UE, to request the UE to switch a user plane connection to a target LMF, where the message carries at least one of the following: a message type, a target LMF address, or the modification cause value, where the modification cause value includes congestion of the LMF, movement of the UE out of the service area of the LMF, or protocol switching.

Step 62b: The UE sends a reply message to the LMF, where the message carries a message type, and indicates that the user plane connection modification request message sent by the first network element is accepted or rejected.

Step 64: The UE initiates a new user plane connection establishment request message to the target LMF after receiving the modification cause value.

Optionally, in a case in which the first information indicates the cause for requesting to release the user plane connection between the terminal and the first network element, the first information includes a third cause value, where the third cause value indicates normal release, protocol switching, resource inadequacy, or restart of the first network element.

In this embodiment, the third cause value indicates the cause for requesting to release the user plane connection between the terminal and the first network element. The cause for requesting to release the user plane connection between the terminal and the first network element may include at least one of the following: normal release, protocol switching, resource inadequacy, or restart of the first network element.

For example, normal release includes normal release cases such as normal release for no use for a long time. Protocol switching may mean that the first network element determines that a currently used protocol stack needs to be switched to transmit a message related to the data service. For example, the LMF determines that a currently used protocol stack needs to be switched to transmit a positioning message. Resource inadequacy may mean that the first network element has an excessively large load, and the terminal needs to wait for a period of time to send a user plane positioning message or search for a replacement network element (for example, an LMF) to provide a service. For example, the LMF has an excessively large computing task load. Restart of the first network element may mean that the first network element requires a machine upgrade and cannot support a current user plane connection task. For example, restart of the LMF means that the LMF requires a machine upgrade and cannot support a current user plane connection task.

It may be understood that when obtaining the third cause value, the terminal may perform a corresponding action based on the third cause value. For example, in a case in which the third cause value indicates normal release, the terminal may reject to release the user plane connection between the terminal and the first network element. In a case in which the third cause value indicates protocol switching, the terminal may release the current user plane connection, and perform user plane communication with the first network element by using the target protocol. In a case in which the third cause value indicates resource inadequacy, the terminal may release the current user plane connection, and re-initiate a terminal triggered user plane connection procedure to request a new network element (for example, an LMF) address to establish a new user plane connection, to send a user plane message, for example, a positioning message. In a case in which the third cause value indicates restart of the first network element, the terminal may release the current user plane connection, and select to establish a user plane connection to another network element.

Optionally, in a case in which the third cause value indicates protocol switching, the first information further includes the target protocol.

In an optional implementation, the first information carries the target protocol information element. The target protocol information element includes the first bit. The first bit represents whether the terminal is required to be switched to the protocol A (for example, the SUPL protocol). When the value of the first bit is 0, the terminal is not required to use the protocol A to transmit the user plane message, for example, the positioning message; or when the value of the first bit is 1, the terminal is required to use the protocol A to transmit the user plane message, for example, the positioning message.

Optionally, the first message further includes the back-off time, and the back-off time indicates that after releasing the current user plane connection, the terminal may re-initiate a user plane connection establishment procedure after waiting for a specified time.

Optionally, the method further includes:

the terminal sends a third message to the first network element, where the third message indicates that a user plane connection release request is accepted or rejected.

For example, that the third message indicates that the user plane connection release request is accepted or rejected may be understood as that the third message indicates that the user plane connection release request message sent by the first network element is accepted or rejected.

In some examples, the third message may carry a fourth message type, and the fourth message type indicates that the user plane connection release request is accepted or rejected.

Specifically, the terminal may determine, based on the first information, whether to accept the user plane connection release request; and when determining to accept the user plane connection release request, send, to the first network element, a message indicating that the user plane connection release request is accepted; or when determining to reject the user plane connection release request, send, to the first network element, a message indicating that the user plane connection release request is rejected.

Optionally, the first message is a message sent by the first network element to the terminal over the user plane, or the first message is a message sent by the first network element to the terminal over the control plane.

In an implementation, the first network element may send the first message to the terminal over the user plane. For example, an LMF may send a user plane connection release request message to UE over a user plane (that is, LMF->UPF->RAN->UE), where the message carries the foregoing first information.

In another implementation, the first network element may send the first message to the terminal over the control plane. For example, an LMF may send a user plane connection release request message to UE over a control plane (that is, LMF->AMF->UE), where the message carries the foregoing first information.

Optionally, the method further includes:

the terminal releases the user plane connection between the terminal and the first network element in a case in which the third message indicates that the user plane connection release request is accepted.

In this embodiment, in a case in which the terminal determines to accept the user plane connection release request, the terminal may release the user plane connection between the terminal and the first network element. Therefore, in a case in which the third cause value indicates resource inadequacy or restart of the first network element, the terminal may select to establish a user plane connection with another network element; or in a case in which the third cause value indicates protocol switching, the terminal re-establishes a user plane connection to the first network element by using the target protocol.

Optionally, the method further includes:

in a case in which the third cause value indicates protocol switching, the terminal performs user plane communication with the first network element by using the target protocol.

For example, in the case in which the third cause value indicates protocol switching, the terminal may release the current user plane connection, that is, release the current user plane connection between the terminal and the first network element, re-establish a user plane connection to the first network element by using the target protocol, and further perform user plane communication with the first network element by using the target protocol.

Optionally, the method further includes:

the terminal sends a fourth user plane connection establishment request message to the second network element in a case in which the third cause value indicates resource inadequacy.

For example, the second network element may be an AMF.

In this embodiment, in the case in which the third cause value indicates resource inadequacy, the terminal may release the current user plane connection, and send the fourth user plane connection establishment request message to the second network element, so that the second network element may reselect a fourth network element for the terminal, to establish a user plane connection between the terminal and the fourth network element. A type of the fourth network element is the same as the type of the first network element. For example, an example in which the first network element is an LMF and the second network element is an AMF is used. The terminal sends the fourth user plane connection establishment request message to the AMF, to request a new LMF address to establish a new user plane positioning connection, to send the user plane message.

The following describes a user plane connection release procedure by using an example in which a data service is a positioning service and the first network element is an LMF.

As shown in FIG. 4c, a user plane connection release procedure between UE and an LMF may include the following steps.

Step 70a: LMF switching requires release of a connection to a current LMF. For details, refer to steps 31a and 31b of the foregoing the user plane connection modification procedure between the UE and the LMF.

Step 70b: The LMF determines, based on a current service load and transmission performance, to release the current connection. For example, the LMF considers that a transmission rate of LCS-UPP is slow, and expects to switch a protocol, for example, switch to SUPL.

It should be noted that only one of step 70a and step 70b is performed.

The LMF sends a release cause value (release cause) to the UE in the following two manners: Manner 1: sending to the UE by using a control plane message (that is, LMF->AMF->UE); and Manner 2: sending to the UE by using a user plane message (that is, LMF->UPF->RAN->UE).

Release manner 1

Step 71a: If the LMF determines to release the current user plane connection, the LMF sends an Namf_Communication_N1N2MessageTransfer message to the AMF, where the message carries a user plane connection release message, and the message carries the release cause value (that is, the third cause value).

Step 72a: When the AMF receives the user plane release message from the LMF, the AMF forwards the user plane connection release message to the UE by using a DL NAS transport message.

Step 73a: The UE sends a user plane connection release response message, where the message may carry a message type indicating that the foregoing user plane connection release request is rejected or accepted, and the message is encapsulated in a UL NAS transport message and sent to the AMF.

Step 74a: When the AMF receives the UL NAS transport message from the UE, the AMF finds an LMF based on an LCS-UP context of the UE, and forwards the user plane connection release response message carried in the UL NAS transport message to the UE.

Release manner 2

Step 71b: The LMF sends a user plane connection release request message to the UE, to request to release a current user plane connection between the UE and the LMF, where the message may carry a message type and the release cause value, where the release cause value includes one of the following: normal release, protocol switching, resource inadequacy, and restart of the LMF.

Optionally, when a release cause is protocol switching, the user plane connection release request message further carries a target protocol.

Step 72b: The UE sends a user plane connection release response message to the LMF, where the message may carry a message type indicating that the foregoing user plane connection release request is rejected or accepted.

Step 73b: After receiving the release request message, the UE releases the current user plane connection, and skips sending a message on the current user plane connection.

In an optional implementation, in a case in which the release cause indicates protocol switching, the UE performs user plane communication with the LMF by using the target protocol.

In an optional implementation, in a case in which the release cause indicates resource inadequacy, the UE may release the current user plane connection, and re-initiate a terminal triggered user plane connection procedure to request a new network element (for example, an LMF) address to establish a new user plane connection, to send a user plane message, for example, a positioning message.

FIG. 5 is a flowchart of a transmission method according to an embodiment of this application. The method may be performed by a network side device. As shown in FIG. 5, the method includes the following step.

Step 501: A first network element sends a first message to a terminal.

The first message carries first information. The first information indicates at least one of the following: whether a first user plane connection establishment request message sent by the terminal is accepted, a cause for requesting to modify a user plane connection between the terminal and the first network element, or a cause for requesting to release the user plane connection between the terminal and the first network element. The first user plane connection establishment request message is used to request to establish the user plane connection between the terminal and the first network element.

Optionally, in a case in which the first information indicates whether the first user plane connection establishment request message sent by the terminal is accepted, the first information includes at least one of the following: a first message type, a first cause value, or the back-off time. The first message type indicates that the user plane connection establishment request is rejected or accepted. The first cause value indicates congestion of the first network element or protocol mismatch.

Optionally, the first user plane connection establishment request message is a user plane connection establishment request message sent by the terminal to the first network element over a user plane.

Optionally, in a case in which the first information indicates the cause for requesting to modify the user plane connection between the terminal and the first network element, the first information includes a second cause value. The second cause value indicates at least one of the following: congestion of the first network element, movement of the terminal out of a service area of the first network element, resource inadequacy, or protocol switching.

Optionally, in a case in which the second cause value indicates protocol switching, the first information further includes a target protocol.

In an optional implementation, the first information carries a target protocol information element (target protocol information element). The target protocol information element includes a first bit. The first bit represents whether the terminal is required to be switched to a protocol A (for example, an SUPL protocol). When a value of the first bit is 0, the terminal is not required to use the protocol A to transmit a user plane message, for example, a positioning message; or when a value of the first bit is 1, the terminal is required to use the protocol A to transmit a user plane message, for example, a positioning message.

Optionally, the first information further includes at least one of the following: a second message type or a target network element address, where the second message type indicates that the first message is used to request to modify the user plane connection.

Optionally, the first message is a message sent by the first network element to the terminal over the user plane, or the first message is a message sent by the first network element to the terminal over a control plane.

Optionally, the method further includes:

the first network element receives a second message sent by the terminal, where the second message indicates that a user plane connection modification request is accepted or rejected.

Optionally, in a case in which the first information indicates the cause for requesting to release the user plane connection between the terminal and the first network element, the first information includes a third cause value, where the third cause value indicates normal release, protocol switching, resource inadequacy, or restart of the first network element.

Optionally, in a case in which the third cause value indicates protocol switching, the first information further includes the target protocol.

In an optional implementation, the first information carries the target protocol information element. The target protocol information element includes the first bit. The first bit represents whether the terminal is required to be switched to the protocol A (for example, the SUPL protocol). When the value of the first bit is 0, the terminal is not required to use the protocol A to transmit the user plane message, for example, the positioning message; or when the value of the first bit is 1, the terminal is required to use the protocol A to transmit the user plane message, for example, the positioning message.

Optionally, the method further includes:

in a case in which the third cause value indicates protocol switching, the first network element performs user plane communication with the terminal by using the target protocol.

Optionally, the first message is a message sent by the first network element to the terminal over the user plane, or the first message is a message sent by the first network element to the terminal over the control plane.

Optionally, the method further includes:

the first network element receives a third message sent by the terminal, where the third message indicates that a user plane connection release request is accepted or rejected.

Optionally, that a first network element sends a first message to a terminal includes:

the first network element sends the first message to the terminal in a case in which the first network element determines, based on a service load and transmission performance, that the user plane connection between the first network element and the terminal needs to be released.

It should be noted that for an implementation of this embodiment, refer to related descriptions in the embodiment shown in FIG. 3. Details are not described herein again.

It should be noted that the transmission method provided in embodiments of this application may be performed by a transmission apparatus, or by a control module of a transmission apparatus that is configured to perform the transmission method. In embodiments of this application, a transmission apparatus provided in embodiments of this application is described by using an example in which the transmission method is performed by the transmission apparatus.

FIG. 6 is a diagram of a structure of a transmission apparatus according to an embodiment of this application. As shown in FIG. 6, the transmission apparatus 600 includes:

a first receiving module 601, configured to receive a first message sent by a first network element.

The first message carries first information. The first information indicates at least one of the following: whether a first user plane connection establishment request message sent by a terminal is accepted, a cause for requesting to modify a user plane connection between the terminal and the first network element, or a cause for requesting to release the user plane connection between the terminal and the first network element. The first user plane connection establishment request message is used to request to establish the user plane connection between the terminal and the first network element.

Optionally, in a case in which the first information indicates whether the first user plane connection establishment request message sent by the terminal is accepted, the first information includes at least one of the following: a first message type, a first cause value, or the back-off time. The first message type indicates that the user plane connection establishment request is rejected or accepted. The first cause value indicates congestion of the first network element or protocol mismatch.

Optionally, the apparatus further includes a second sending module, specifically configured to:

start a timer in a case in which the first information includes the back-off time, and send a second user plane connection establishment request message to the first network element after the timer expires, where an initial value of the timer is the back-off time; or

send a third user plane connection establishment request message to a second network element in a case in which the first cause value indicates protocol mismatch, where the third user plane connection establishment request message includes at least one of the following: first indication information or a protocol used by the terminal, where the first indication information indicates the second network element to select a third network element supporting the protocol used by the terminal.

Optionally, the first user plane connection establishment request message is a user plane connection establishment request message sent by the terminal to the first network element over a user plane.

Optionally, in a case in which the first information indicates the cause for requesting to modify the user plane connection between the terminal and the first network element, the first information includes a second cause value. The second cause value indicates at least one of the following: congestion of the first network element, movement of the terminal out of a service area of the first network element, resource inadequacy, or protocol switching.

Optionally, the first information further includes at least one of the following: a second message type or a target network element address, where the second message type indicates that the first message is used to request to modify the user plane connection.

Optionally, the first message is a message sent by the first network element to the terminal over the user plane, or the first message is a message sent by the first network element to the terminal over a control plane.

Optionally, the apparatus further includes:

a third sending module, configured to send a second message to the first network element, where the second message indicates that a user plane connection modification request is accepted or rejected.

Optionally, in a case in which the first information indicates the cause for requesting to release the user plane connection between the terminal and the first network element, the first information includes a third cause value, where the third cause value indicates normal release, protocol switching, resource inadequacy, or restart of the first network element.

Optionally, in a case in which the third cause value indicates protocol switching, the first information further includes a target protocol.

Optionally, the apparatus further includes:

a fourth sending module, configured to send a third message to the first network element, where the third message indicates that a user plane connection release request is accepted or rejected.

Optionally, the apparatus further includes:

a release module, configured to release the user plane connection between the terminal and the first network element in a case in which the third message indicates that the user plane connection release request is accepted.

Optionally, the apparatus further includes:

a first communication module, configured to: in a case in which the third cause value indicates protocol switching, perform user plane communication with the first network element by using the target protocol.

Optionally, the first message is a message sent by the first network element to the terminal over the user plane, or the first message is a message sent by the first network element to the terminal over the control plane.

Optionally, the apparatus further includes:

a fifth sending module, configured to send a fourth user plane connection establishment request message to the second network element in a case in which the third cause value indicates resource inadequacy.

The transmission apparatus in this embodiment of this application may be an electronic device, for example, an electronic device having an operating system, or a component in an electronic device, such as an integrated circuit or a chip. The electronic device may be a terminal, or may be another device other than a terminal. For example, the terminal may include but is not limited to the types of the terminal 11 listed above, and the another device may be a server, a network attached storage (Network Attached Storage, NAS), or the like. This is not specifically limited in embodiments of this application.

The transmission apparatus provided in this embodiment of this application can implement processes implemented in the method embodiment in FIG. 3, and achieve same technical effects. To avoid repetitions, details are not described herein again.

FIG. 7 is a diagram of a structure of a transmission apparatus according to an embodiment of this application. As shown in FIG. 7, the transmission apparatus 700 includes:

a first sending module 701, configured to send a first message to a terminal.

The first message carries first information. The first information indicates at least one of the following: whether a first user plane connection establishment request message sent by the terminal is accepted, a cause for requesting to modify a user plane connection between the terminal and a first network element, or a cause for requesting to release the user plane connection between the terminal and the first network element. The first user plane connection establishment request message is used to request to establish the user plane connection between the terminal and the first network element.

Optionally, in a case in which the first information indicates whether the first user plane connection establishment request message sent by the terminal is accepted, the first information includes at least one of the following: a first message type, a first cause value, or the back-off time. The first message type indicates that the user plane connection establishment request is rejected or accepted. The first cause value indicates congestion of the first network element or protocol mismatch.

Optionally, the first user plane connection establishment request message is a user plane connection establishment request message sent by the terminal to the first network element over a user plane.

Optionally, in a case in which the first information indicates the cause for requesting to modify the user plane connection between the terminal and the first network element, the first information includes a second cause value. The second cause value indicates at least one of the following: congestion of the first network element, movement of the terminal out of a service area of the first network element, resource inadequacy, or protocol switching.

Optionally, the first information further includes at least one of the following: a second message type or a target network element address, where the second message type indicates that the first message is used to request to modify the user plane connection.

Optionally, the first message is a message sent by the first network element to the terminal over the user plane, or the first message is a message sent by the first network element to the terminal over a control plane.

Optionally, the apparatus further includes:

a second receiving module, configured to receive a second message sent by the terminal, where the second message indicates that a user plane connection modification request is accepted or rejected.

Optionally, in a case in which the first information indicates the cause for requesting to release the user plane connection between the terminal and the first network element, the first information includes a third cause value, where the third cause value indicates normal release, protocol switching, resource inadequacy, or restart of the first network element.

Optionally, in a case in which the third cause value indicates protocol switching, the first information further includes a target protocol.

Optionally, the apparatus further includes:

a second communication module, configured to: in a case in which the third cause value indicates protocol switching, perform user plane communication with the terminal by using the target protocol.

Optionally, the first message is a message sent by the first network element to the terminal over the user plane, or the first message is a message sent by the first network element to the terminal over the control plane.

Optionally, the apparatus further includes:

a third receiving module, configured to receive a third message sent by the terminal, where the third message indicates that a user plane connection release request is accepted or rejected.

Optionally, the first sending module is further configured to:

send, by the first network element, the first message to the terminal in a case in which the first network element determines, based on a service load and transmission performance, that the user plane connection between the first network element and the terminal needs to be released.

The transmission apparatus in this embodiment of this application may be an electronic device, for example, an electronic device having an operating system, or a component in an electronic device, such as an integrated circuit or a chip. The electronic device may be a network side device, or may be another device other than a network side device. For example, the network side device may include but is not limited to the types of the network side device 12 listed above, and the another device may be a server, a network attached storage (Network Attached Storage, NAS), or the like. This is not specifically limited in embodiments of this application.

The transmission apparatus provided in this embodiment of this application can implement processes implemented in the method embodiment in FIG. 5, and achieve same technical effects. To avoid repetitions, details are not described herein again.

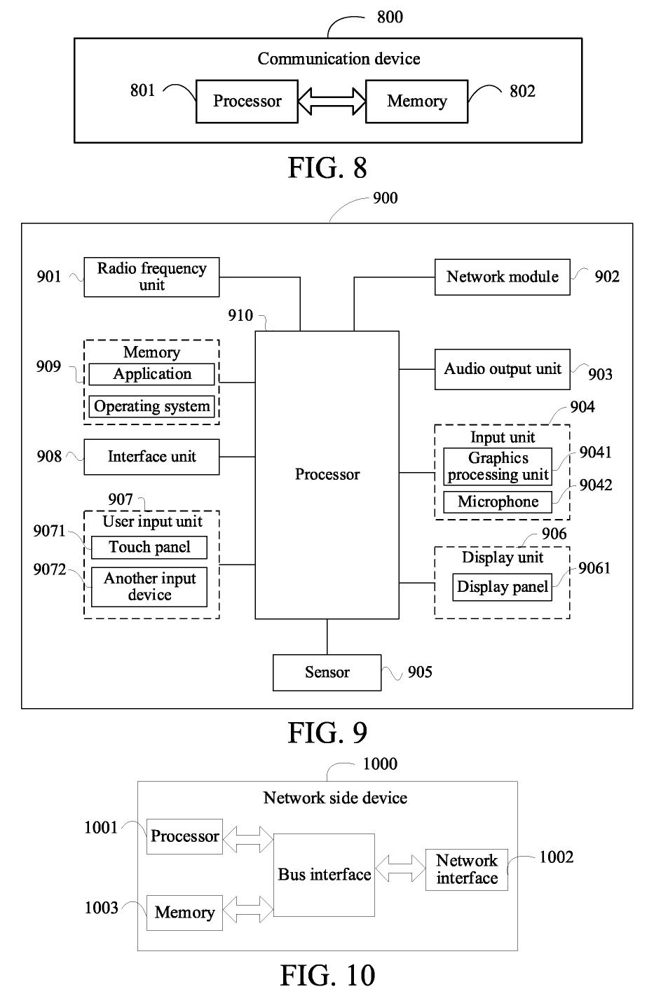

Optionally, as shown in FIG. 8, an embodiment of this application further provides a communication device 800, including a processor 801 and a memory 802. The memory 802 stores a program or instructions runnable on the processor 801. For example, when the communication device 800 is a terminal, the program or the instructions are executed by the processor 801 to implement the steps in the foregoing transmission method embodiment, and the same technical effects can be achieved. When the communication device 800 is a network side device, the program or the instructions are executed by the processor 801 to implement the steps in the foregoing transmission method embodiment, and the same technical effects can be achieved. To avoid repetitions, details are not described herein again.

An embodiment of this application further provides a terminal, including a processor and a communication interface. The communication interface is configured to receive a first message sent by a first network element. The first message carries first information. The first information indicates at least one of the following: whether a first user plane connection establishment request message sent by the terminal is accepted, a cause for requesting to modify a user plane connection between the terminal and the first network element, or a cause for requesting to release the user plane connection between the terminal and the first network element. The first user plane connection establishment request message is used to request to establish the user plane connection between the terminal and the first network element. This terminal embodiment corresponds to the foregoing method embodiment for a terminal side. The implementation processes and implementations of the foregoing method embodiment all may be applied to this terminal embodiment, and the same technical effects can be achieved. Specifically, FIG. 9 is a diagram of a hardware structure of a terminal for implementing an embodiment of this application.

The terminal 900 includes but is not limited to at least a part of components such as a radio frequency unit 901, a network module 902, an audio output unit 903, an input unit 904, a sensor 905, a display unit 906, a user input unit 907, an interface unit 908, a memory 909, and a processor 910.

It can be understood by a person skilled in the art that the terminal 900 may further include a power supply (for example, a battery) supplying power to the components. The power supply may be logically connected to the processor 910 via a power management system, so that functions such as charge and discharge management and power consumption management are implemented via the power management system. The structure of the terminal shown in FIG. 9 does not constitute any limitation on the terminal, and the terminal may include more or fewer components than shown in the diagram, combine some of the components, or have different arrangements of the components. Details are not described herein.

It should be understood that in this embodiment of this application, the input unit 904 may include a graphics processing unit (Graphics Processing Unit, GPU) 9041 and a microphone 9042. The graphics processing unit 9041 processes image data of a static picture or a video that is obtained by an image capture apparatus (for example, a camera) in a video capture mode or an image capture mode. The display unit 906 may include a display panel 9061. The display panel 9061 may be configured in a form of a liquid crystal display, an organic light-emitting diode, or the like. The user input unit 907 includes at least one of a touch panel 9071 or another input device 9072. The touch panel 9071 is also referred to as a touchscreen. The touch panel 9071 may include two parts: a touch detection apparatus and a touch controller. The another input device 9072 may include but is not limited to a physical keyboard, a function button (for example, a volume control button or a power on/off button), a trackball, a mouse, and a joystick. Details are not described herein again.

In this embodiment of this application, after receiving downlink data from a network side device, the radio frequency unit 901 may transmit the data to the processor 910 for processing. In addition, the radio frequency unit 901 may send uplink data to the network side device. Generally, the radio frequency unit 901 includes but is not limited to an antenna, an amplifier, a transceiver, a coupler, a low noise amplifier, a duplexer, and the like.

The memory 909 may be configured to store a software program or instructions and various data. The memory 909 may mainly include a first storage region storing the program or the instructions and a second storage region storing the data. The first storage region may store an operating system, an application or instructions required for at least one function (for example, a sound play function and an image play function), and the like. In addition, the memory 909 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DR RAM). The memory 909 in this embodiment of this application includes but is not limited to these and any other suitable types of memories.

The processor 910 may include one or more processing units. Optionally, the processor 910 integrates an application processor and a modem processor. The application processor mainly processes operations related to the operating system, a user interface, an application, and the like. The modem processor mainly processes a wireless communication signal, and is, for example, a baseband processor. It may be understood that the modem processor may alternatively not be integrated into the processor 910.

The radio frequency unit 901 is configured to receive a first message sent by a first network element. The first message carries first information. The first information indicates at least one of the following: whether a first user plane connection establishment request message sent by the terminal is accepted, a cause for requesting to modify a user plane connection between the terminal and the first network element, or a cause for requesting to release the user plane connection between the terminal and the first network element. The first user plane connection establishment request message is used to request to establish the user plane connection between the terminal and the first network element.

It may be understood that for implementation processes of the implementations in this embodiment, refer to the related descriptions in the method embodiment, and the same or corresponding technical effects are achieved. To avoid repetitions, details are not described herein again.

An embodiment of this application further provides a network side device, including a processor and a communication interface. The communication interface is configured to send a first message to a terminal. The first message carries first information. The first information indicates at least one of the following: whether a first user plane connection establishment request message sent by the terminal is accepted, a cause for requesting to modify a user plane connection between the terminal and a first network element, or a cause for requesting to release the user plane connection between the terminal and the first network element. The first user plane connection establishment request message is used to request to establish the user plane connection between the terminal and the first network element. This network side device embodiment corresponds to the foregoing method embodiment for the network side device. The implementation processes and implementations of the foregoing method embodiment all may be applied to this network side device embodiment, and the same technical effects can be achieved.

Specifically, an embodiment of this application further provides a network side device. As shown in FIG. 10, the network side device 1000 includes a processor 1001, a network interface 1002, and a memory 1003. The network interface 1002 is, for example, a common public radio interface (a common public radio interface, CPRI).

Specifically, the network side device 1000 in this embodiment of this application further includes instructions or a program stored in the memory 1003 and runnable on the processor 1001. The processor 1001 invokes the instructions or the program in the memory 1003 to perform the method performed by the modules shown in FIG. 7, and the same technical effects are achieved. To avoid repetitions, details are not described herein again.

An embodiment of this application further provides a readable storage medium. The readable storage medium stores a program or instructions. When the program or the instructions are executed by a processor, the processes in the foregoing transmission method embodiment are implemented, and the same technical effects can be achieved. To avoid repetitions, details are not described herein again.

The processor is a processor in the terminal described in the foregoing embodiments. The readable storage medium includes a computer-readable storage medium, for example, a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface. The communication interface is coupled to the processor. The processor is configured to run a program or instructions to implement the processes in the foregoing transmission method embodiment, and the same technical effects can be achieved. To avoid repetitions, details are not described herein again.

It should be understood that the chip mentioned in embodiments of this application may also be referred to as a system-level chip, a system chip, a chip system, a system on chip, or the like.

An embodiment of this application further provides a computer program/program product. The computer program/program product is stored in a storage medium. The computer program/program product is executed by at least one processor to implement the processes in the foregoing transmission method embodiment, and the same technical effects can be achieved. To avoid repetitions, details are not described herein again.

An embodiment of this application further provides a transmission system, including a terminal and a network side device. The terminal is configured to perform the processes in FIG. 3 and each method embodiment. The network side device is configured to perform the processes in FIG. 5 and each method embodiment. The same technical effects can be achieved. To avoid repetitions, details are not described herein again.

It should be noted that in this specification, the terms "include" and "comprise" or any other variant thereof is intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by "including a/an..." does not preclude existence of other identical elements in the process, method, article, or apparatus that includes the element. In addition, it should be noted that the scope of the method and apparatus in the implementations of this application is not limited to performing the functions in the order shown or discussed, but may also include performing the functions in a substantially simultaneous manner or in a reverse order depending on the functions involved. For example, the described method may be performed in an order different from that described, and various steps may be added, omitted, or combined. In addition, features described with reference to some examples may be combined in other examples.

According to the descriptions of the foregoing implementations, a person skilled in the art can clearly understand that the method in the foregoing embodiments may be implemented by a computer software product in addition to a necessary universal hardware platform or by hardware only. The computer software product is stored in a storage medium (for example, a ROM, a RAM, a magnetic disk, or an optical disc), and includes several instructions for instructing a terminal or a network side device to perform the method described in embodiments of this application.

The foregoing describes embodiments of this application with reference to the accompanying drawings. However, this application is not limited to these specific implementations. The specific implementations are merely illustrative rather than restrictive. Inspired by this application, a person of ordinary skill in the art may develop many other implementations without departing from the principle of this application and the protection scope of the claims, and all such implementations fall within the protection scope of this application.

What is claimed is:

1. A transmission method, comprising:
receiving, by a terminal, a first message sent by a first network element, wherein
the first message carries first information, and the first information indicates at least one of the following: whether a first user plane connection establishment request message sent by the terminal is accepted, a cause for requesting to modify a user plane connection between the terminal and the first network element, or a cause for requesting to release the user plane connection between the terminal and the first network element, wherein the first user plane connection establishment request message is used to request to establish the user plane connection between the terminal and the first network element.

2. The method according to claim 1, wherein in a case in which the first information indicates whether the first user plane connection establishment request message sent by the terminal is accepted, the first information comprises at least one of the following: a first message type, a first cause value, or back-off time, wherein the first message type indicates that a user plane connection establishment request is rejected or accepted, and the first cause value indicates congestion of the first network element or protocol mismatch.

3. The method according to claim 2, wherein the method further comprises:
starting, by the terminal, a timer in a case in which the first information comprises the back-off time, and sending a second user plane connection establishment request message to the first network element after the timer expires, wherein an initial value of the timer is the back-off time;
or
sending, by the terminal, a third user plane connection establishment request message to a second network element in a case in which the first cause value indicates protocol mismatch, wherein the third user plane connection establishment request message comprises at least one of the following: first indication information or a protocol used by the terminal, wherein the first indication information indicates the second network element to select a third network element supporting the protocol used by the terminal.

4. The method according to claim 1, wherein the first user plane connection establishment request message is a user plane connection establishment request message sent by the terminal to the first network element over a user plane.

5. The method according to claim 1, wherein in a case in which the first information indicates the cause for requesting to modify the user plane connection between the terminal and the first network element, the first information comprises a second cause value, wherein the second cause value indicates at least one of the following: congestion of the first network element, movement of the terminal out of a service area of the first network element, resource inadequacy, or protocol switching.

6. The method according to claim 5, wherein the first information further comprises at least one of the following: a second message type or a target network element address, wherein the second message type indicates that the first message is used to request to modify the user plane connection.

7. The method according to claim 5, wherein the first message is a message sent by the first network element to the terminal over the user plane, or the first message is a message sent by the first network element to the terminal over a control plane.

8. The method according to claim 5, wherein the method further comprises:
sending, by the terminal, a second message to the first network element, wherein the second message indicates that a user plane connection modification request is accepted or rejected.

9. The method according to claim 1, wherein in a case in which the first information indicates the cause for requesting to release the user plane connection between the terminal and the first network element, the first information comprises a third cause value, wherein the third cause value indicates normal release, protocol switching, resource inadequacy, or restart of the first network element.

10. The method according to claim 9, wherein in a case in which the third cause value indicates protocol switching, the first information further comprises a target protocol.

11. A transmission method, comprising:
sending, by a first network element, a first message to a terminal, wherein
the first message carries first information, and the first information indicates at least one of the following: whether a first user plane connection establishment request message sent by the terminal is accepted, a cause for requesting to modify a user plane connection between the terminal and the first network element, or a cause for requesting to release the user plane connection between the terminal and the first network element, wherein the first user plane connection establishment request message is used to request to establish the user plane connection between the terminal and the first network element.

12. The method according to claim 11, wherein in a case in which the first information indicates whether the first user plane connection establishment request message sent by the terminal is accepted, the first information comprises at least one of the following: a first message type, a first cause value, or back-off time, wherein the first message type indicates that a user plane connection establishment request is rejected or accepted, and the first cause value indicates congestion of the first network element or protocol mismatch.

13. The method according to claim 11, wherein the first user plane connection establishment request message is a user plane connection establishment request message sent by the terminal to the first network element over a user plane.

14. The method according to claim 11, wherein in a case in which the first information indicates the cause for requesting to modify the user plane connection between the terminal and the first network element, the first information comprises a second cause value, wherein the second cause value indicates at least one of the following: congestion of the first network element, movement of the terminal out of a service area of the first network element, resource inadequacy, or protocol switching.

15. The method according to claim 14, wherein the first information further comprises at least one of the following: a second message type or a target network element address, wherein the second message type indicates that the first message is used to request to modify the user plane connection.

16. The method according to claim 14, wherein the first message is a message sent by the first network element to the terminal over the user plane, or the first message is a message sent by the first network element to the terminal over a control plane.

17. The method according to claim 14, wherein the method further comprises:
receiving, by the first network element, a second message sent by the terminal, wherein the second message indicates that a user plane connection modification request is accepted or rejected.

18. The method according to claim 11, wherein in a case in which the first information indicates the cause for requesting to release the user plane connection between the terminal and the first network element, the first information comprises a third cause value, wherein the third cause value indicates normal release, protocol switching, resource inadequacy, or restart of the first network element.

19. A terminal, comprising a processor and a memory, wherein the memory stores a program or instructions executable on the processor, and when the program or the instructions are executed by the processor, the steps of a transmission method, wherein the method comprises:
receiving, by the terminal, a first message sent by a first network element, wherein
the first message carries first information, and the first information indicates at least one of the following: whether a first user plane connection establishment request message sent by the terminal is accepted, a cause for requesting to modify a user plane connection between the terminal and the first network element, or a cause for requesting to release the user plane connection between the terminal and the first network element, wherein the first user plane connection establishment request message is used to request to establish the user plane connection between the terminal and the first network element.

20. A network side device, comprising a processor and a memory, wherein the memory stores a program or instructions executable on the processor, and when the program or the instructions are executed by the processor, the steps of the transmission method according to claim 11 are implemented.
